(19) United States
(12) Patent Application Publication
(10) Pub. No.: US 2004/0061381 A1
(43) Pub. Date: Apr. 1, 2004

(54) Switch device

(76) Inventor: Yi Ting Chen, Kweishan (TW)

Correspondence Address: BROWDY AND NEIMARK, P.L.L.C., 624 NINTH STREET, NW, SUITE 300, WASHINGTON, DC, 20001-5303, US

(21) Appl. No.: 10/255,944

(22) Filed: Sep. 27, 2002

(51) Int. Cl. H02J 1/00

(52) U.S. Cl. 307/43

(57) ABSTRACT

A switch device includes a regulating circuit, a loading unit, a battery, an alternating voltage detecting loop and a voltage-increasing loop. The regulating circuit serves to regulate an inputted alternating voltage. The loading unit is connected to an output terminal of the regulating circuit, and operates when receiving a voltage outputted from the regulating circuit. The battery is connected to an output terminal of the loading unit. The battery keeps charging while the loading unit is working. The alternating voltage detecting loop is respectively connected to the regulating circuit and the battery. The voltage-increasing loop is respectively connected to the alternating voltage detecting loop and the battery. When the alternating voltage detecting loop works, the voltage-increasing loop generates oscillation to increase the power of the nickel hydrogen battery and drive the loading unit.

### BACKGROUND OF THE INVENTION

1. Field of the Invention

The invention relates to a switch device and, more particularly, to a switch device including a regulating circuit, a loading unit and an alternating voltage detecting loop. When the voltage from the regulating circuit can not be directly input to the loading unit, which is detected by the alternating voltage detecting loop, the voltage-increasing loop increases the power of the battery to keep the loading unit working.

2. Description of the Related Art

FIG. 1 shows a conventional switch device having a light emitter. The conventional switch device includes silicon control regulator (SCR), a photosensitive resistor, a light emitting diode and resistors R1, R2 in a switch frame (not shown). When the photosensitve resistor does not receive any light, the SCR is at ON status to drive the LED.

However, when circuits in the switch frame fail to receive an input voltage, the switch can not work. Furthermore, the LED is easily affected by the fluctuation of the input voltage, and therefore can not steadily emit light with sufficient intensity.

### SUMMARY OF THE INVENTION

It is therefore a principal object of the invention to provide a switch device that works when a voltage from the regulating circuit can not be directly inputted to the loading unit.

To accomplish the above and other objectives, a switch device of the invention comprises a regulating circuit, a loading unit, an alternating voltage detecting loop and a voltage-increasing loop. When the voltage from the regulating circuit can not be directly inputted to the loading unit, which is detected by the alternating voltage detecting loop, the voltage-increasing loop lo increases the power of the battery to keep the loading unit working.

To provide a further understanding of the invention, the following detailed description illustrates embodiments and examples of the invention, this detailed description being provided only for illustration of the invention.

### BRIEF DESCRIPTION OF THE DRAWINGS

The drawings included herein provide a further understanding of the invention. A brief introduction of the drawings is as follows:

FIG. 1 is a circuit layout of a conventional switch device;

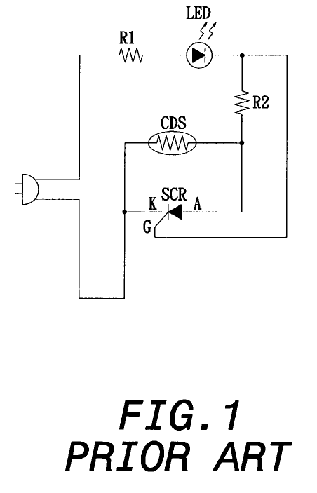

FIG. 2 is a block diagram of a switch device according to an embodiment of the invention;

FIG. 3 is a circuit layout of a switch device according to an embodiment of the invention; and

FIG. 4 is a perspective view of a switch device according to an embodiment of the present invention.

### DETAILED DESCRIPTION OF THE EMBODIMENT

Wherever possible in the following description, like reference numerals will refer to like elements and parts unless otherwise illustrated.

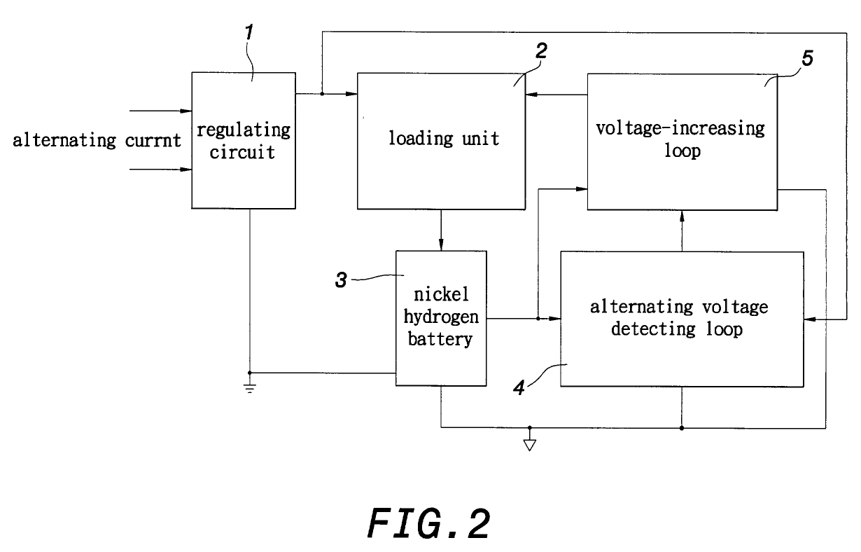

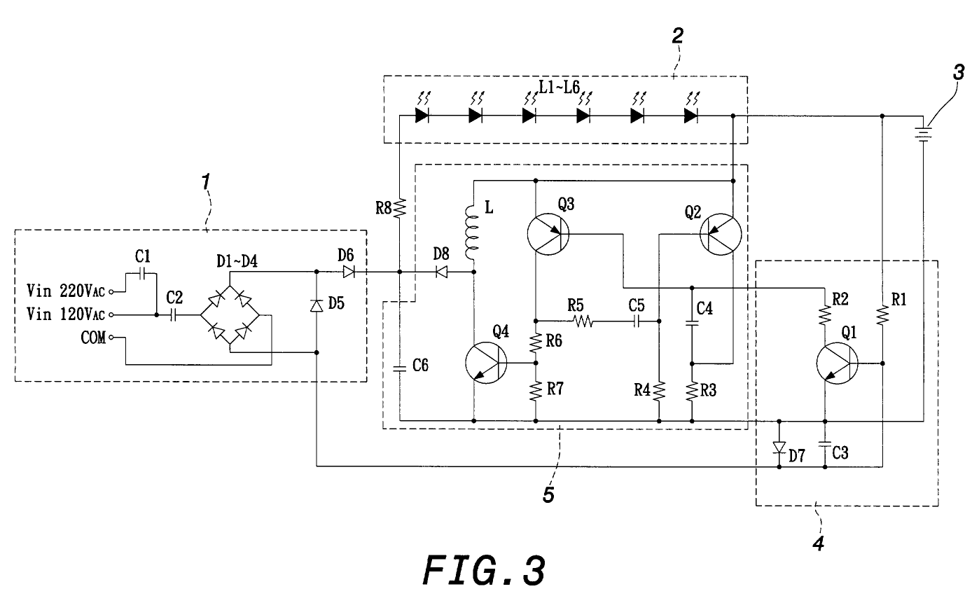

With reference to FIG. 2 and FIG. 3, a switch device according to the invention includes a regulating circuit 1, a loading unit 2, a battery 3, an alternating voltage detecting loop 4 and a voltage-increasing loop 5.

The regulating circuit 1 includes a plurality of capacitors C1 and C2, a plurality of regulators D1-D4 and a plurality of diodes D5 and D6. The regulating circuit 1 regulates an inputted alternating voltage such as 220 V or 110V.

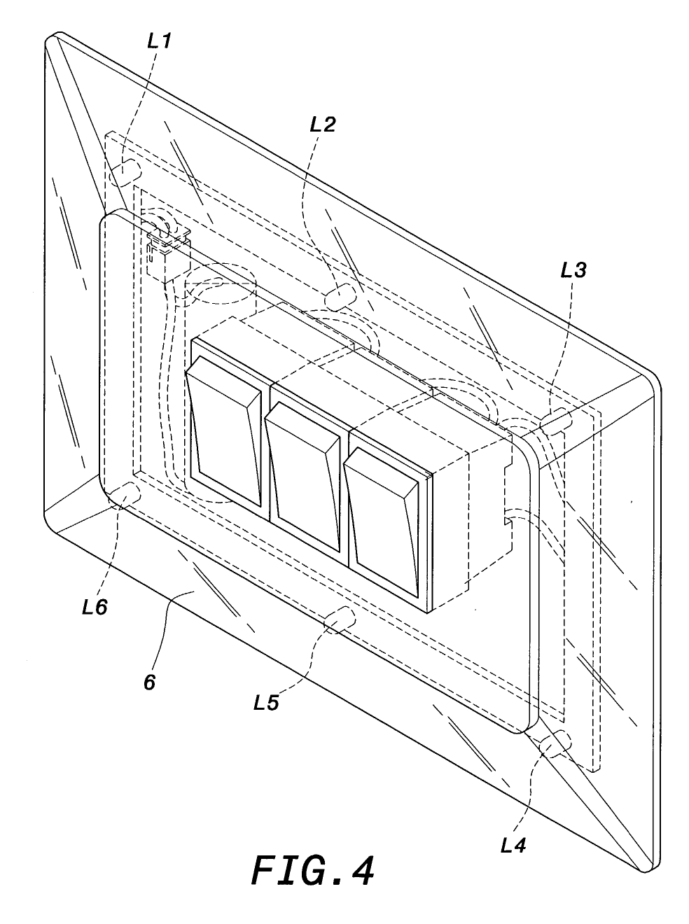

The loading unit 2 is connected to an output terminal of the regulating circuit 1. According to one embodiment of the invention, the loading unit 2 is a switch frame 6 including a plurality of light emitters, such as light-emitting diodes (LED) L1-L6 connected in series, as shown in FIG. 4. Each of the LED L1-L6 emits a monochromatic or polychromatic light when receiving a voltage outputted from the regulating circuit 1.

The battery 3 can be, for example, a nickel-hydrogen battery. A positive electrode of the battery 3 is connected to an output terminal of the loading unit 2. The nickel hydrogen battery keeps charging while the loading unit 2 is working.

The alternating voltage detecting loop 4 is respectively connected to the regulating circuit 1 and the battery 3. The alternating voltage detecting loop 4 includes a transistor Q1, a plurality of resistors R1, R2, a capacitor C3 and a diode D7. The transistor Q1 has a base, an emitter and a collector. The base of the transistor Q1 is connected to the positive electrode of the battery 3 and the resistors R1. The emitter of the transistor Q 1 is connected to the capacitor C3 and the positive terminal of the diode D7. The collector of the transistor Q1 is connected to the resistor R2.

When the voltage from the regulating circuit 1 can not be directly inputted to the loading unit 2, which is detected by the alternating voltage detecting loop 4, the battery 3 provides the operational voltage to keep the transistor Q1 to be at ON status.

The voltage-increasing loop 5 is respectively connected to the alternating voltage detecting loop 4 and the battery 3. The voltage-increasing loop 5 includes a plurality of transistors Q2, Q3, Q4, a plurality of capacitors C4-C6, a plurality of resistors R3-R7, a coil L and a diode D8. The transistors Q2-Q3, the capacitors C4, C5 and the resistors R3-R5 form an oscillating loop. An output terminal of the oscillating loop is connected to a circuit constituting by the transistor Q4, the transistor R6 and the resistor R7. Terminals of the coil L are respectively connected to a collector of the transistor Q4 and the positive electrode of the battery 3.

When the alternating voltage detecting loop 4 works, the voltage-increasing loop 5 generates oscillation to increase the power of the battery 3 and drive the loading unit 2.

According to the invention, the loading unit 2 can work by receiving the output voltage from the regulating circuit 1. Alternatively, when the voltage from the regulating circuit 1 can not be directly inputted to the loading unit -2, which is detected by the alternating voltage detecting loop 4, the voltage-increasing loop 5 increases the power of the battery 3 to keep the loading unit 2 working.

In a view of the above, the invention provides the following advantages over the prior art. For example, when the voltage from the regulating circuit can not be directly inputted to the loading unit, the loading unit still keeps working. The light emission of the LED is not adversely affected by the fluctuation of the alternating voltage. Therefore, the switch device of the invention is more particularly advantageous in, for example, emergency lighting, indicators, traffic signals and the like.

Those skilled in the art will readily appreciate that the above description is only illustrative of specific embodiments and examples of the invention. The invention should therefore cover various modifications and variations made to the herein-described structure and operations of the invention, provided they fall within the scope of the invention as defined in the following appended claims.

What is claimed is:

1. A switch device comprising:
a regulating circuit, regulating an input alternating voltage;
a loading unit, connected to an output terminal of the regulating circuit, wherein the loading unit operates when receiving a voltage outputted from the regulating circuit;
a battery, connected to an output terminal of the loading unit, wherein the battery keeps charging while the loading unit is working;
an alternating voltage detecting loop, respectively connected to the regulating circuit and the battery; and
a voltage-increasing loop, respectively connected to the alternating voltage detecting loop and the battery, wherein when the alternating voltage detecting loop works the voltage-increasing loop generates oscillation to increase a power of the battery and drive the loading unit.

2. The device of claim 1, wherein the loading unit is a switch frame including a plurality of light emitters.

3. The device of claim 2, wherein the light emitting device is a light emitting diode (LED).

4. The device of claim 1, wherein the switch device is used in an emergency lighting, indicator, traffic signal.

5. The device of claim 1, wherein the battery is a nickel hydrogen battery.

6. The device of claim 1, wherein the voltage-increasing loop includes a plurality of transistors, a plurality of capacitors, a plurality of resistors, a coil and a diode.
